(19) United States
(12) Patent Application Publication
(10) Pub. No.: US 2022/0012679 A1
(43) Pub. Date: Jan. 13, 2022

(54) PRODUCT MANAGEMENT APPARATUS, PRODUCT MANAGEMENT SYSTEM, PRODUCT MANAGEMENT METHOD, AND TERMINAL APPARATUS

(71) Applicant: Toyota Jidosha Kabushiki Kaisha, Toyota-shi Aichi-ken (JP)

(72) Inventors: Shin Sakurada, Toyota-shi (JP); Hirotada Nakanishi, Toyota-shi (JP); Atsushi Inoue, Nagoya-shi (JP); Hideo Hasegawa, Nagoya-shi (JP); Yurika Tanaka, Yokosuka-shi (JP); Genshi Kuno, Kasugai-shi (JP)

(21) Appl. No.: 17/363,588

(22) Filed: Jun. 30, 2021

(30) Foreign Application Priority Data
Jul. 7, 2020 (JP) 2020-117375

(51) Int. Cl. G06Q 10/08; G06Q 10/04; G05D 1/02; G05D 1/00

(52) U.S. Cl. CPC G06Q 10/087; G06Q 10/04; G05D 2201/0216; G05D 1/0088; G05D 1/0278

(57) ABSTRACT

A product management apparatus includes an information acquisition interface and a controller. The information acquisition interface is configured to acquire, from a terminal apparatus, information related to requests from a user. The controller is configured to apply a purchased tag to a product, based on a purchase request from the user that is acquired using the information acquisition interface, the purchased tag identifying that the product is a purchased product of the user, cause the product to which the purchased tag is applied to be unloaded from a predetermined storage space, based on a receipt request from the user that is acquired using the information acquisition interface; and remove the purchased tag, based on a return request from the user that is acquired using the information acquisition interface.

### CROSS-REFERENCE TO RELATED APPLICATION

This application claims priority to Japanese Patent Application No. 2020-117375 filed on Jul. 7, 2020, the entire contents of which are incorporated herein by reference.

### TECHNICAL FIELD

The present disclosure relates to a product management apparatus, a product management system, a product management method, and a terminal apparatus.

### BACKGROUND

Systems have been developed to support stocking by determining, for each household, a menu based on an inventory quantity of food and, based on the determined menu, determine food items for which demand is anticipated as stock (for example, Patent Literature 1).

### CITATION LIST

### Patent Literature

PTL 1: JP 2013-250697 A

### SUMMARY

When each household purchases products such as food, these products sometimes turn out to be no longer needed after purchase. If the no longer needed products cannot be returned or resold, they may be wasted.

It would be helpful to reduce product waste.

A product management apparatus according to an embodiment of the present disclosure includes:

an information acquisition interface; and

a controller, wherein

the information acquisition interface is configured to acquire, from a terminal apparatus, information related to requests from a user, and

the controller is configured to:

apply a purchased tag to a product, based on a purchase request from the user that is acquired using the information acquisition interface, the purchased tag identifying that the product is a purchased product of the user;

set the product to which the purchased tag is applied to a ready-to-be-received state, based on a receipt request from the user that is acquired using the information acquisition interface; and

remove the purchased tag, based on a return request from the user that is acquired using the information acquisition interface.

A product management system according to an embodiment of the present disclosure includes the product management apparatus and the terminal apparatus.

A product management method according to an embodiment of the present disclosure includes:

applying a purchased tag to a product, based on a purchase request from a user, the purchased tag identifying that the product is a purchased product of the user;

providing the product to which the purchased tag is applied to the user, based on a receipt request from the user; and

removing the purchased tag, based on a return request from the user.

A terminal apparatus according to an embodiment of the present disclosure includes

a controller configured to:

receive, from a user, a purchase request for a product and output the purchase request to a product management apparatus;

when a receipt request for the product to which a purchased tag is applied based on the purchase request for the product is received from the user, output the receipt request for the product to the product management apparatus, and receive an input confirming that the user has received the product to produce an output to the product management apparatus; and

when a return request for the product to which the purchased tag is applied is received from the user, output the return request for the product to the product management apparatus.

According to the product management apparatus, the product management system, the product management method, and the terminal apparatus according to the embodiments of the present disclosure, product waste may be reduced.

### BRIEF DESCRIPTION OF THE DRAWINGS

In the accompanying drawings:

FIG. 1 is a schematic diagram illustrating a configuration example of a product management system according to an embodiment;

FIG. 2 is a block diagram illustrating a configuration example of the product management system according to the embodiment;

FIG. 3 is a flowchart illustrating an example of a procedure for a product management method; and

FIG. 4 is a flowchart illustrating an example of a procedure for a terminal control method.

### DETAILED DESCRIPTION

(Product Management System 1)

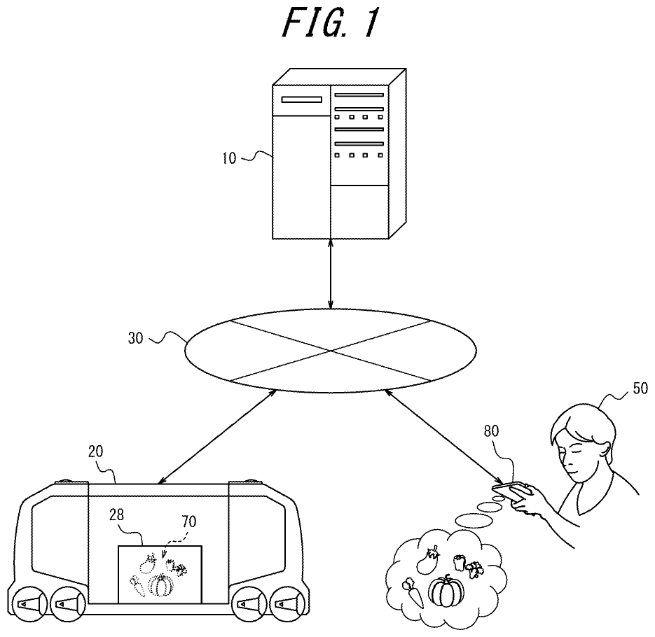

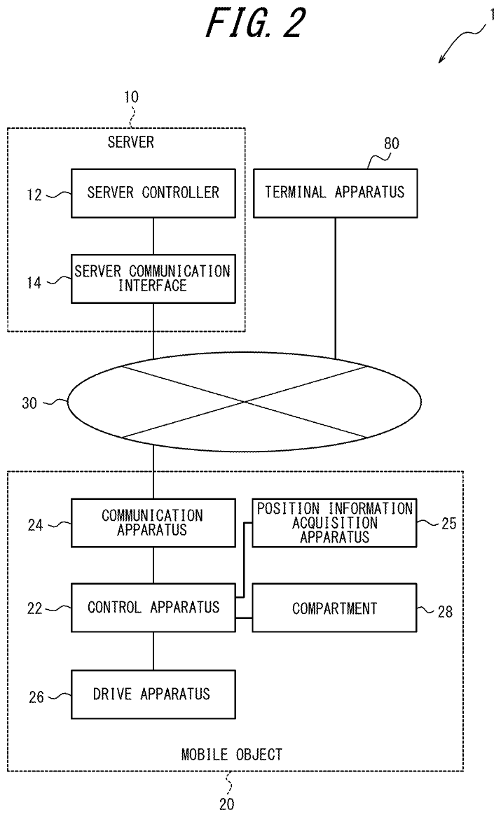

As illustrated in FIGS. 1 and 2, a product management system 1 according to an embodiment includes a server 10 and a terminal apparatus 80. The product management system 1 further includes, but is not required to include, a mobile object 20. The server 10, the terminal apparatus 80, and the mobile object 20 are connected to a network 30 and are communicable with each other. Each of the server 10, the terminal apparatus 80, and the mobile object 20 is not limited to one and may be two or more in number.

The product management system 1 is operated mainly by a retailer, a wholesaler, or the like, that sells a product 70, and provides a sales service for sale of the product 70 to a user 50. The sales service includes a service in which the user 50 is able to purchase the product 70 in a manner such that the user 50 can receive the product at desired timing without having to immediately receive the product 70. The sales service also includes a service in which the user 50 is able to return the purchased product 70 before actual receipt.

The sales service is provided, for example, by the following procedure. The user 50 inputs, to the terminal apparatus 80, a purchase request for the product 70. The server 10 acquires, from the terminal apparatus 80, information related to purchase request of the user 50 for the product 70. The server 10 applies a purchased tag to the product 70 and stores, in a predetermined storage space, the product 70 to which the purchased tag is applied until the product 70 is delivered to the user 50. The purchased tag indicates the right for the user 50 to receive the product 70 to which the purchased tag is applied. That is, by being applied to the product 70, the purchased tag identifies that the product 70 is the product purchased by the user 50.

The user 50, when in need of the purchased product 70, inputs, to the terminal apparatus 80, a receipt request for the purchased product 70. The server 10 acquires, from the terminal apparatus 80, information related to the receipt of the product 70 by the user 50. The server 10 unloads the product 70 purchased by the user 50 from the predetermined storage space for delivery to the user 50. The predetermined storage space may include, for example, a shop, a warehouse, or the like. The predetermined storage space may include, for example, a refrigerator, a freezer, or the like. The unloaded product 70 is delivered to the user 50 by various methods, such as delivery by shop staff, the user 50 visiting the shop themself, or the like. As the methods for delivering the unloaded product 70 to the user 50, for example, the mobile object 20 may be used as described later.

When the purchased product 70 is no longer needed, the user 50 inputs, to the terminal apparatus 80, a return request for the purchased product 70. The server 10 acquires, from the terminal apparatus 80, information related to return of the product 70 by the user 50. The server 10 removes the purchased tag that has been applied to the product 70 based on the purchase request of the user 50. The server 10 may remove the purchased tag from the product 70 while the product 70 remains stored in the predetermined storage space.

As described above, the provision of the sales service makes it easier for the user 50 to receive the product 70 only when it is actually needed and to return the product 70 when it is no longer needed. As a result, waste of the product 70 may be reduced.

Hereinafter, a specific configuration and operations of the product management system 1 for providing the sales service will be described.

<Server 10>

The server 10 transmits and receives various types of information related to the provision of the sales service to and from the terminal apparatus 80. For example, the server 10 acquires, from the terminal apparatus 80, information related to the purchase, the receipt, or the return of the product 70 that is inputted to the terminal apparatus 80 by the user 50. The server 10 applies the purchased tag to the product 70 or removes the purchased tag from the product 70. The server 10 outputs management information for the product 70 to be stored in the predetermined storage space or to be unloaded from the predetermined storage space. The server 10 may be configured to execute, in addition to the above processing, various types of processing related to the provision of the sales service. The server 10 is also referred to as a product management apparatus. The server 10 may include a single server apparatus, or a plurality of server apparatuses capable of communicating with each other.

The server 10 includes a server controller 12 and a server communication interface 14.

The server controller 12 may include at least one processor. The server controller 12 is also referred to simply as a controller. The “processor” in the present embodiment may be, but is not limited to, a general-purpose processor, or a dedicated processor that is dedicated to specific processing. The server controller 12 may include at least one dedicated circuit. Examples of dedicated circuits may include a Field-Programmable Gate Array (FPGA) and an Application Specific Integrated Circuit (ASIC). The server controller 12 may include the dedicated circuit instead of the processor, or may include the dedicated circuit along with the processor. The server 10 may include a memory. The memory may be, but is not limited to, a semiconductor memory, a magnetic memory, or an optical memory. The memory may function as, for example, a main memory, an auxiliary memory, or a cache memory. The memory may include an electromagnetic storage medium, such as a magnetic disc. The memory may include a non-transitory computer readable medium. The memory may store any information used for operations of the server 10. For example, the memory may store a system program, an application program, or the like. The memory may be included in the server controller 12 or may be configured separately from the server controller 12.

The server communication interface 14 includes a communication module and may communicate with the terminal apparatus 80 or with the mobile object 20. The server communication interface 14 is also referred to simply as a communication interface. The server 10 may include, instead of the server communication interface 14, an interface for acquiring information and may receive, from the terminal apparatus 80 via the interface, the information related to the purchase, and the receipt or the return of the product 70 that is inputted to the terminal apparatus 80 by the user 50. The server 10 may include both the server communication interface 14 and the interface. The server communication interface 14 and the interface for acquiring information are collectively referred to as an information acquisition interface. That is, the server 10 may include the information acquisition interface.

<Terminal Apparatus 80>

The terminal apparatus 80 accepts inputs from the user 50 requesting to purchase and receive or return the product 70 and outputs the inputs to the server 10.

The terminal apparatus 80 includes a processor for executing processing for realizing various functions. The processor may be configured in a similar manner to the processor that constitutes the server controller 12.

The terminal apparatus 80 may further include an input device for receiving the input from the user 50. The input apparatus may include, for example, a touch panel, a keyboard, or the like. The input device may include an audio input device, such as a microphone.

Terminal apparatus 80 may further include an output device for notifying the user 50 of information. The output device may include, for example, a display device, or may include an audio output device such as a speaker. The display device may include, for example, a variety of displays, such as a liquid crystal display, a plasma display, or an organic or inorganic Electro-Luminescent (EL) display. The display device may include a light emitting apparatus, such as a Light Emitting Diode (LED).

The terminal apparatus 80 may include, for example, a mobile terminal, such as a smart phone. The terminal apparatus 80 may include a portable terminal, such as a tablet Personal Computer (PC) or a notebook PC. The terminal apparatus 80 may include, for example, a desktop PC or the like.

The terminal apparatus 80 may be in the possession of the user 50. In this case, the user 50 may make the purchase request for the product 70 from a place outside the shop, such as their home, using the terminal apparatus 80 in their possession.

The terminal apparatus 80 may be installed in the shop that sells the product 70. In this case, the user 50 may make the purchase request for the product 70 in the shop. When the terminal apparatus 80 is installed in the shop, the terminal apparatus 80 may be operated by the shop staff or the like as an operator.

The terminal apparatus 80 may be installed in the predetermined storage space. When the terminal apparatus 80 is installed in the predetermined storage space, the terminal apparatus 80 may be operated by staff or the like in the storage space as an operator. When, for example, the user 50 makes the return request or the receipt request, the operator of the terminal apparatus 80 may obtain the content of the request made by the user 50 by telephone, or by various communication techniques, such as a chat tool or an e-mail, and input the content to the terminal apparatus 80 on behalf of the user 50.

<Mobile Object 20>

The mobile object 20 may function as a method for delivering the product 70 to the user 50. When the mobile object 20 delivers the product 70 to the user 50, the mobile object 20 receives the product 70 that is unloaded at the predetermined storage space, travels from the predetermined storage space to a location of the user 50, and delivers the product 70 to the user 50.

When the mobile object 20 delivers the product 70 to the user 50, the server controller 12 may control the mobile object 20. The server controller 12 may communicate with the mobile object 20 to thereby acquire various types of information related to the mobile object 20, such as a position or a speed of the mobile object 20. The server controller 12 may be configured to execute, in addition to the above processing, various types of processing for controlling the mobile object 20.

The mobile object 20 may include a vehicle, such as Micro-Pallet. The mobile object 20 may include, for example, a flying object such as a drone. The mobile object 20 may be configured to operate using automated driving. In a case in which the mobile object 20 is a vehicle, the automated driving may be, for example, performed at any level from Level 1 to Level 5 as defined by the Society of Automotive Engineers (SAE). The automated driving may be performed based on other definitions without being limited to the exemplified definition.

The mobile object 20 includes a control apparatus 22, a communication apparatus 24, and a drive apparatus 26. The control apparatus 22, the communication apparatus 24, and the drive apparatus 26 are communicably connected to each other, for example, via an in-vehicle network, such as a Controller Area Network (CAN), or a dedicated line.

The control apparatus 22 controls the components included in the mobile object 20. The control apparatus 22 may include at least one processor. The control apparatus 22 may include at least one dedicated circuit instead of the processor, or may include at least one dedicated circuit along with the processor. The control apparatus 22 may further include a memory.

The communication apparatus 24 communicates with the server 10 via the network 30. The communication apparatus 24 may communicate with the terminal apparatus 80 via the network 30, or may communicate with the terminal apparatus 80 without using the network 30. The communication apparatus 24 may be, for example, an in-vehicle communication device. The communication apparatus 24 may include a communication module for connection with the network 30. The communication module may include, but is not limited to, a communication module conforming to a mobile communication standard, such as the 4^{th} Generation (4G) standard or the 5^{th} Generation (5G) standard.

The drive apparatus 26 functions as motive power for moving the mobile object 20. In a case in which the mobile object 20 is a vehicle, such as Micro-Pallet, the drive apparatus 26 may include wheels driven by an engine, a motor, or the like. In a case in which the mobile object 20 is a drone, the drive apparatus 26 may include a propeller driven by an engine, a motor, or the like. The mobile object 20 may include a plurality of drive apparatuses 26 and may change a direction of movement by controlling output power from each drive apparatus 26. The mobile object 20 may further include a steering apparatus for controlling the direction of movement.

The mobile object 20 further includes a compartment 28 in which the product 70 is carried. The compartment 28 may include a space that can store the product 70 while controlling the temperature of the product 70, such as a refrigerator or freezer.

The mobile object 20 further includes, but is not required to include, a positional information acquisition apparatus 25. The positional information acquisition apparatus 25 is connected to other components mounted in the mobile object 20 via the in-vehicle network, such as the CAN, or the dedicated line, so as to be communicable with each other. The positional information acquisition apparatus 25 acquires the positional information for the mobile object 20. The positional information acquisition apparatus 25 may include a receiver compliant with a satellite positioning system. The receiver compliant with the satellite positioning system may include, for example, a Global Positioning System (GPS) receiver. In the present embodiment, the mobile object 20 can acquire the positional information for the mobile object 20 itself using the positional information acquisition apparatus 25. The mobile object 20 may output the positional information for the mobile object 20 itself to the server 10.

The control apparatus 22 acquires control information for the mobile object 20 from the server controller 12 via the communication apparatus 24. Based on the control information, the control apparatus 22 controls the drive apparatus 26 and controls the mobile object 20. The control apparatus 22 may cause the mobile object 20 to travel, further based on the positional information for the mobile object 20.

<Storage of Product 70 by Moving Object 20>

The mobile object 20 may not only transport the product 70 as described above, but may also make the compartment 28 function as the predetermined storage space that stores the product 70. When the compartment 28 functions as the predetermined storage space, the server controller 12 may cause the mobile object 20 to receive the product 70 from the shop, the warehouse, or the like, and carry the received product 70 in the compartment 28 as inventory. The server controller 12 may cause the mobile object 20 to deliver the product 70. The server controller 12 may cause the mobile object 20 to return, to the shop, the warehouse, or the like, the product 70 which is carried as the inventory in the compartment 28. Instead of the terminal apparatus 80, the control apparatus 22 installed in the mobile object 20 may apply the purchased tag to the product 70 carried as the inventory or may remove the purchased tag from the product 70.

<Summary>

As described above, the product management system 1 according to the present embodiment allows the user 50 to purchase the product 70, and delivers the product 70 to the user 50 when needed, and accepts the return of the product 70 from the user 50 when it is no longer needed. In this way, the user 50 can receive the product 70 when needed, and can easily return the product 70 when it is no longer needed. As a result, waste of the product 70 is reduced. With the product management system 1, return processing is realized without having to actually deliver the product 70. That is, the product management system 1 can realize virtual return processing. Further, the user 50 does not need to store, in their home or the like, the product 70 that is not likely to be consumed immediately after purchase. This may increase space at home or the like that the user 50 can freely use. Consequently, the convenience for the user 50 is improved.

In other words, the product management system 1 according to the present embodiment can provide a shared storage space for a plurality of users 50. That is, the storage space is shared across an area in which the plurality of users 50 reside. When the predetermined storage space includes the refrigerator or the freezer, the refrigerator or the freezer is shared across the area in which the plurality of users 50 reside.

<Example of Flowchart for Product Management Method>

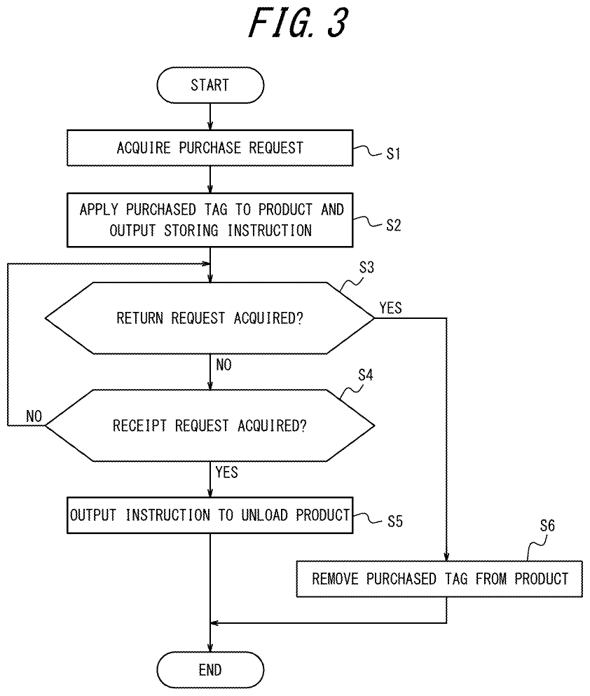

The server controller 12 of the server 10 included in the product management system 1 may execute a product management method including the procedure of the flowchart illustrated in FIG. 3. The product management method may be implemented as a product management program to be executed by a processor, such as the server controller 12. The product management program may be stored on a non-transitory computer readable medium.

The server controller 12 acquires, from the terminal apparatus 80, information related to a purchase request for the product 70 made by the user 50 (Step S1).

The server controller 12 applies the purchased tag to the product 70 and outputs an instruction to store the product 70 in the predetermined storage space (Step S2).

The server controller 12 determines whether information related to a return request for the product 70 made by the user 50 has been acquired from the terminal apparatus 80 (Step S3). When the server controller 12 determines that information related to a return request has been acquired (Step S3: YES), processing proceeds to Step S6.

When determining that information related to a return request has not been acquired (Step 3: NO), the server controller 12 determines whether information related to a receipt request for the product 70 made by the user 50 has been acquired from the terminal apparatus 80 (Step S4). When the server controller 12 determines that information related to a receipt request has not been acquired (Step S4: NO), the processing returns to Step S3.

When determining that information related to a receipt request has been acquired (Step S4: YES), the server controller 12 outputs an instruction to unload the product 70 from the predetermined storage space (Step S5). The product 70 unloaded from the predetermined storage space is delivered to the user 50. After executing the procedure in Step S5, the server controller 12 ends the execution of the procedure in the flowchart of FIG. 3.

When determining that information related to a return request has been acquired (Step S3: YES), the server controller 12 removes the purchased tag from the product 70 (Step S6). After executing the procedure in Step S6, the server controller 12 ends the execution of the procedure in the flowchart of FIG. 3.

With the product management method according to the present embodiment, the user 50 can receive the purchased product 70 when the product 70 is needed, and can easily make a return when the product 70 is no longer needed. As a result, waste of the product 70 is reduced.

The product management method may include a procedure for executing processing based on an expiration date of the product 70 to which the purchased tag is applied. For example, the product management method may include a procedure for outputting an instruction to notify the user 50 of an alarm when the number of days until the expiration date of the product 70 to which the purchased tag is applied is less than or equal to a predetermined number of days. The alarm notified to the user 50 may include information requesting the user 50 to select whether to receive or return the product 70. The product management method may also include a procedure for removing the purchased tag from the product 70 when the number of days until the expiration date of the product 70 to which the purchased tag is applied is less than or equal to the predetermined number of days. By executing processing based on the expiration date of the product 70, waste of the product 70 may be reduced.

<Example of Flowchart for Terminal Control Method>

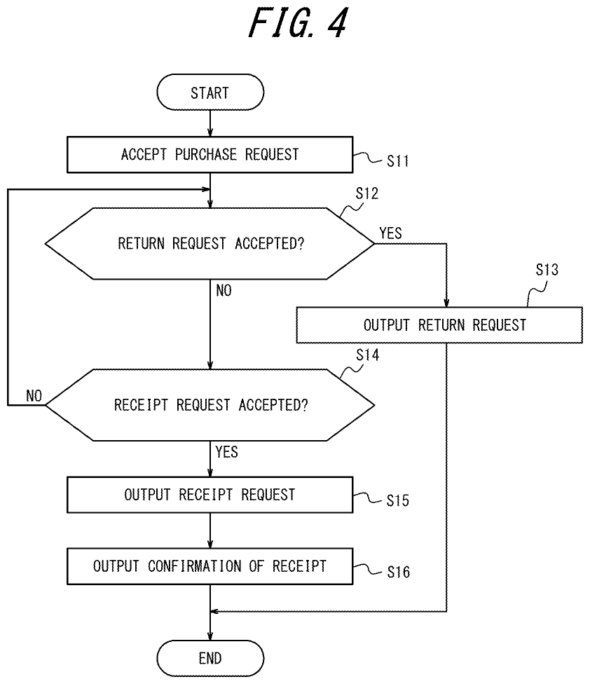

The terminal apparatus 80 included in the product management system 1 may execute a terminal control method including the procedure of the flowchart illustrated in FIG. 4. The terminal control method may be implemented as a terminal control program to be executed by the processor of the terminal apparatus 80. The terminal control program may be stored on a non-transitory computer readable medium. It is assumed that the procedure illustrated below is executed by the terminal apparatus 80 possessed by the user 50.

The terminal apparatus 80 accepts, from the user 50, a purchase request for the product 70 (Step S11). The terminal apparatus 80 outputs the accepted request to the server 10. The server 10 applies the purchased tag to the product 70 for which the user 50 has made the purchase request.

The terminal apparatus 80 determines whether a return request for the product 70 has been accepted from the user 50 (Step S12).

When determining that a return request has been accepted (Step S12: YES), the terminal apparatus 80 outputs, to the server 10, the information related to the return request for the product 70 to which the purchased tag is applied (Step S13). After executing the procedure of Step S13, the terminal apparatus 80 ends the execution of the procedure in the flowchart of FIG. 4.

When determining that a return request has not been accepted (Step S12: NO), the terminal apparatus 80 determines whether a receipt request for the product 70 has been accepted from the user 50 (Step S14). When the terminal apparatus 80 determines that a receipt request has not been accepted (Step S14: NO), the processing returns to Step S12.

When determining a receipt request has been accepted (Step S14: YES), the terminal apparatus 80 outputs, to the server 10, the information related to the receipt request for the product 70 to which the purchased tag is applied (Step S15). The server 10 unloads, from the predetermined storage space, the product 70 which is the subject of the receipt request and outputs an instruction to deliver the product to the user 50.

The terminal apparatus 80 receives an input confirming that the user 50 has received the product 70 to produce an output to the server 10 (Step S16). After executing the procedure of Step S16, the terminal apparatus 80 ends the execution of the procedure in the flowchart of FIG. 4.

With the terminal control method according to the present embodiment, the user 50 can receive the purchased product 70 when the product 70 is needed, and can easily make a return when the product 70 is no longer needed. As a result, waste of the product 70 is reduced.

### Another Embodiment

### <Unit Management of Product 70>

The product 70 includes a plurality of units. The product 70 may be managed on a unit basis. Each unit of the product 70 may be distinguished by a variety of features. For example, each unit of the product 70 may be distinguished by appearance, such as size or color. Each unit of the product 70 may be distinguished by place of origin. Each unit of the product 70 may be distinguished by production time, or consume by date or best before date.

The user 50 may make a purchase request for a single product 70 of one type. In this instance, the server controller 12 may apply a purchased tag to a single unit of the product 70 which is the subject of the request. The user 50 may make a purchase request for a plurality of products 70 of the same type. In this instance, the server controller 12 may apply a purchased tag to each of the units of the products 70 which are the subjects of the request.

The user 50 may make a purchase request for the product 70 by specifying the feature of a unit. In this instance, the server controller 12 may apply a purchased tag to a unit that matches the feature specified by the user 50, or to a unit which is as close as possible to the feature specified by the user 50.

The server controller 12 may apply a purchased tag on the unit basis as described above, but may also apply a purchased tag to the product 70 without distinguishing between each unit. When a purchased tag is applied to the product 70 without distinguishing between each unit, the product 70 to be delivered in response to the receipt request from the user 50 may be any unit included in the product 70.

The server controller 12 may apply, to a single unit, two or more purchased tags based on respective purchase requests from two or more users 50. That is, a double-booking state in which the two or more users 50 have the right to receive the single unit may be allowed. When two or more purchased tags are applied to the single unit, the server controller 12 outputs an instruction to unload and deliver the unit to one of the users 50 based on a receipt request for the product 70 made by one of the users 50. Then, the server controller 12 reapplies another purchased tag applied to the unloaded unit to another unit of the same type as the product 70 stored as the inventory.

By thus allowing the double-booking state, even if, for example, one of the purchased tags is removed from the certain unit based on the return request from one of the users 50, another purchased tag remains applied to that unit. This makes it unlikely that the product 70 is left unsold. As a result, a loss incurred by the shop due to acceptance of return requests from the users 50 may be reduced.

When the number of return requests from the users 50 is less than expected, there may be a shortage of the product 70. In this situation, the server controller 12 may provide an alternative product 70 or grant a compensatory incentive to any user 50 who is unable to receive the product 70.

Further, when the user 50 makes a purchase request for the product 70 by specifying a feature of a unit, one possible situation is that only a unit that lacks the specified feature can be delivered. In this situation, the server controller 12 may provide a different unit of the same type as the product 70 or grant a compensatory incentive to the user 50 who is unable to receive the unit having the specified feature.

The server controller 12 may provide an incentive to a user 50 who has made a receipt request for a product 70 to which a purchased tag is applied. By doing so, the number of return requests can be reduced. As a result, the loss incurred by the shop due to acceptance of return requests from the users 50 may be reduced.

As the incentive, the server controller 12 may grant the right for preferential receipt of the product 70, when, for example, the user 50 makes the next purchase request or the next receipt request for the product 70. The incentive may be granted, for example, as points that can be used for payment of a purchase price of the product 70. The incentive may be granted as electronic money. The incentive may be granted as points that can be exchanged for valuables or a paid service.

<Inventory Quantity of Product 70>

Regardless of whether purchased tags are applied with each unit being distinguished, the server controller 12 may determine an inventory quantity of a certain type of the product 70 based on the number of purchased tags applied to the certain type of the product 70 as a whole. In this way, inventory management is easier. As a result, waste of the product 70 may be reduced.

The server controller 12 may determine, for the certain type of the product 70, the inventory quantity of the certain type of product 70 based on a percentage of products 70 to which the purchased tags are applied and for which return requests are made. The percentage for which return requests are made is calculated by dividing the number of returns without receipt despite previously made purchase requests by the number of the purchase requests. The server controller 12 may forecast, for the certain type of the product 70, the percentage for which return requests are to be made and determine the inventory quantity of that type of the product 70 based on the forecasting.

<Forecasting for Content of Request Based on Behavior History of User 50>

The server controller 12 may acquire a behavior history of the user 50. The behavior history of the user 50 may include, for example, a history of the purchases, the receipts, and the returns of the product 70. The behavior history of the user 50 may include, for example, a travel history of the user 50. Based on the behavior history of the user 50, the server controller 12 may forecast the product 70 for which the user 50 is to make a purchase request and apply a purchased tag to the forecasted product 70. This saves the user 50 the trouble of making the purchase request. Consequently, the convenience for the user 50 is improved.

<Forecasting for Time of Receipt of Product 70>

The server controller 12 may forecast a time at which the user 50 is to receive the product 70 to which the purchased tag is already applied for the user 50, and manage the inventory of the product 70 based on a result of the forecasting. Further, the server controller 12 may determine to which one of the plurality of units included in the product 70 the purchased tag is to be applied, based on the result of the forecasting. For example, when the product 70 has a time limit, such as a best before date or a consume by date, the server controller 12 may determine to which unit the purchased tag is to be applied further based on the time limit set for each unit. The product 70 for which the time limit, such as the best before date or the consume by date, is set is also referred to as a time-limited product. The server controller 12 may preferentially apply the purchased tag to a unit that is closest to the time limit set among the units included in the time-limited product. By doing so, the product 70 is more likely to be delivered to the user 50 before the time limit set. As a result, waste of the product 70 may be reduced.

The server controller 12 may forecast a time at which a receipt request for the product 70 to which the purchased tag is applied is to be made by one user 50. When a receipt request for the product 70 to which the purchased tag is applied is made by another user 50 prior to the forecasted time, the server controller 12 may deliver the product 70 to which the purchased tag is applied to the other user 50. The server controller 12 may preferentially deliver, to the user 50, a unit whose time limit, which is set for each unit, is approaching, regardless of to which unit the purchased tag is applied. By doing so, the management of the time limit of the product 70 is easier. As a result, waste of the product 70 may be reduced.

The embodiments according to the present disclosure have been described based on the drawings and examples. The present disclosure is not limited to the embodiments described above. For example, functions or the like included in each step, or the like can be rearranged without logical inconsistency, and a plurality steps, or the like can be combined together or divided. Other modifications may be made without departing from the gist of the present disclosure.

1. A product management apparatus comprising:
an information acquisition interface; and
a controller, wherein
the information acquisition interface is configured to acquire, from a terminal apparatus, information related to requests from a user, and
the controller is configured to:
apply a purchased tag to a product, based on a purchase request from the user that is acquired using the information acquisition interface, the purchased tag identifying that the product is a purchased product of the user;
set the product to which the purchased tag is applied to a ready-to-be-received state, based on a receipt request from the user that is acquired using the information acquisition interface; and
remove the purchased tag, based on a return request from the user that is acquired using the information acquisition interface.

2. The product management apparatus according to claim 1, wherein
the controller is configured to cause the product to which the purchased tag is applied to be stored in a predetermined storage space as inventory, and cause the product to which the purchased tag is applied to be unloaded from the predetermined storage space based on the receipt request from the user.

3. The product management apparatus according to claim 1, wherein
the controller is configured to:
apply two or more purchased tags to a single unit of the product; and
when the unit is delivered to a user who has a right to receive the unit based on one of the two or more purchased tags, reapply other purchased tags to other units of the product.

4. The product management apparatus according to claim 1, wherein
the controller is configured to forecast the product for which the user is to make the purchase request based on a behavior history of the user, and apply the purchased tag to the forecasted product.

5. The product management apparatus according to claim 1, wherein
the controller is configured to:
forecast a time at which a receipt request for the product to which the purchased tag is applied is to be made from a user; and
when the receipt request for the product to which the purchased tag is applied is made by another user prior to the forecasted time, deliver the product to which the purchased tag is applied to the other user.

6. The product management apparatus according to claim 1, wherein
the controller is configured to grant an incentive to the user who has made the receipt request for the product to which the purchased tag is applied.

7. The product management apparatus according to claim 1, wherein
the controller is configured to determine an inventory quantity of the product, based on the number of purchased tags applied to the product.

8. The product management apparatus according to claim 7, wherein
the controller is configured to determine the inventory quantity of the product, further based on a percentage of products to which the purchased tags are applied and for which a return request is made.

9. The product management apparatus according to claim 1, wherein
the product includes a time-limited product for which a best before date or a consume by date is set.

10. The product management apparatus according to claim 9, wherein
the controller is configured to apply the purchased tag to a unit that is closest to a time limit among a plurality of units included in the time-limit product.

11. A product management system comprising:
the product management apparatus according to claim 1; and
the terminal apparatus.

12. A product management method comprising:
applying a purchased tag to a product, based on a purchase request from a user, the purchased tag identifying that the product is a purchased product of the user;
providing the product to which the purchased tag is applied to the user, based on a receipt request from the user; and
removing the purchased tag, based on a return request from the user.

13. The product management method according to claim 12, further comprising:
applying two or more purchased tags to a single unit of the product; and
when the unit is delivered to a user who has a right to receive the unit based on one of the two or more purchased tags, reapplying other purchased tags to other units of the product.

14. The product management method according to claim 12, further comprising:
forecasting the product for which the user is to make the purchase request based on a behavior history of the user; and
applying the purchased tag to the forecasted product.

15. The product management method according to claim 12, further comprising:
forecasting a time at which a receipt request for the product to which the purchased tag is applied is to be made from a user; and
when the receipt request for the product to which the purchased tag is applied is made by another user prior to the forecasted time, delivering the product to which the purchased tag is applied to the other user.

16. The product management method according to claim 12, further comprising
granting an incentive to the user who has made the receipt request for the product to which the purchased tag is applied.

17. The product management method according to claim 12, further comprising
determining an inventory quantity of the product, based on the number of purchased tags applied to the product.

18. The product management method according to claim 17, further comprising
determining the inventory quantity of the product, further based on a percentage of products to which the purchased tags are applied and for which a return request is made.

19. The product management method according to claim 12, wherein
the product includes a time-limited product for which a best before date or a consume by date is set.

20. A terminal apparatus comprising
a controller configured to:
receive, from a user, a purchase request for a product and output the purchase request to a product management apparatus;
when a receipt request for the product to which a purchased tag is applied based on the purchase request for the product is received from the user, output the receipt request for the product to the product management apparatus, and receive an input confirming that the user has received the product to produce an output to the product management apparatus; and
when a return request for the product to which the purchased tag is applied is received from the user, output the return request for the product to the product management apparatus.
